(19) United States
(12) Patent Application Publication
(10) Pub. No.: US 2021/0073919 A1
(43) Pub. Date: Mar. 11, 2021

(54) MICRO-SELF-TAXING BANKING TRANSACTION AND METHOD

(71) Applicant: Live, Give, Save, Inc., Red Wing, MN (US)

(72) Inventors: Susan Sorensen Langer, Red Wing, MN (US); Ajay R. Nair, Concord, NC (US)

(21) Appl. No.: 17/098,275

(22) Filed: Nov. 13, 2020

Related U.S. Application Data
(63) Continuation of application No. 15/877,669, filed on Jan. 23, 2018, now abandoned.
(60) Provisional application No. 62/449,505, filed on Jan. 23, 2017.

(51) Int. Cl. G06Q 40/00; G06Q 30/02; G06Q 50/00; G06Q 20/10; G06Q 20/02; G07F 17/32

(52) U.S. Cl. CPC G06Q 40/10; G06Q 30/0279; G06Q 50/01; G07F 17/3255; G06Q 20/023; G07F 17/3258; G06Q 20/108

(57) ABSTRACT

A self-taxing device allows a consumer/payer/donor to allocate a small percentage or the like of each purchase to be added savings and/or donated to charity of the consumer's choice. In operation, the consumer will preauthorize withdrawals from their checking/working account which are based upon purchases made from their credit, debit, checking or savings account(s). These small amounts are held in a bucket/sweep account until a threshold in time or currency is reached, then a transfer is made to the charity or to savings. The consumer may also choose to participate in a social media platform which may automatically or manually post messages regarding donations to the charity or other benchmarks.

### STATEMENT REGARDING FEDERALLY FUNDED RESEARCH

This invention was not made under contract with an agency of the US Government, nor by any agency of the US Government.

### CROSS-REFERENCE TO RELATED APPLICATIONS

N/A

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE INVENTION

This invention relates generally to banking transactions, and particularly to methods of transferring and paying money during purchases so as to cause user controlled self taxation.

### BACKGROUND OF THE INVENTION

In recent years society has seen a marked rise in consumer spending on credit, the demise of consumer savings for retirement, and an ongoing desire to give more to charity. This is especially true for the younger Millennial generation. There are many causes for this, but what is more clear than ever is the need to provide a solution. There are solutions today that can independently address charitable giving and saving, however, there is no single solution that addresses both in a simple, engaging and automated fashion. Technology is also readily available, with the power only previously available to large enterprises is now being placed in the hands of consumers.

There has also been a dramatic drop in charitable giving following the Great Recession in 2008, causing a major disruption among non-profit organizations struggling to adjust to changing times, attitudes and behaviors among donors. Economic conditions diverted personal giving in response to lost jobs, reductions in pay, changes in benefits, evaporated housing wealth, etc. As a result, the realities of managing these changes while preserving the integrity of the nation's outreach programs has become a challenge. Donors, corporations and private foundations altered their strategies, tightened their criteria and amplified expectations, making it increasingly more difficult and stressful for non-profits to keep up with operational instability as resources were stretched and depleted all the while demands for service increased. The result has been a perfect storm where needs rapidly outpaced available resources.

Atop all that, a major shift within the market was occurring motivated by an explosion in new technologies available—particularly mobile—driven by the entrance of Millennials. Also known as the “me” generation, Millennials are anti-establishment, demand transparency, control and ease of engagement.

It takes a tremendous amount of effort to change consumer behavior, but there is power and potential in using EXISTING behaviors in consumer spending to transform financial futures, in a way that organically increases charitable giving and boosts savings through a payment transaction process that enables micro-self-taxing.

In the area of allowing automatic diversions from payments into savings and donations, there are relatively few entries of interest. www.betterment.com offers a robo-financial-advisor with reduced fees and no account minimum, while www.acorns.com offers a round-up method for investing spare change into a mutual fund. Both suffer from some obvious deficiencies: lack of flexibility as to how much money is transferred, an emphasis on investment only with no charitable aspect, Acorns is only mutual fund related, and so on. A system named Mint uses spending to help a user by providing better advice about budgeting, while Stash takes spare change and deposits it into an ETF. Digit on the other hand uses a special algorithm to calculate what they believe that the user can afford to save and then transfers that amount from checking to saving.

It would be preferable to provide something neither of these two items provide: the ability to engage in micro-self-taxing combined with both micro-saving and micro-charitable contribution. It would further be preferable to allow the user great flexibility in how this is done.

It would be preferable to provide a method and financial transaction facility for fostering savings (such as retirement savings) and charitable giving through existing consumer behaviors.

It would further be preferable to provide a very flexible method of managing one's own micro-self-taxation to fulfill giving and saving plans.

It would yet further be preferable to provide a method of aggregating consumer transaction data into valuable databases, including data not available through the normal ACH transaction process template.

It would further be preferable to provide a financial service which could utilize the power of modern mobile devices to achieve these ends.

It would further be preferable to provide a financial service facility offering transparency and ease of engagement at both the time of initial setup and at later times as well.

It would further be preferable to provide a social media oriented functionality to the financial transaction facility, so that users could feel not just connected via monetary donations to the charity of their choice, but also feel connected to a network of like-minded individuals and experience the impact of their generosity.

All of these aspects, advantages, objectives and embodiments are met by the financial service and transaction facility, and the method thereof, embodied in the present invention.

### SUMMARY OF THE INVENTION

### General Summary

The present invention teaches an improved method and a financial system for allowing a consumer/payer/user/donor to micro-self-tax themselves on every payment they make, with the proceeds of the self-taxing going into their savings account (or other savings accounts for other purposes such as college savings, trip savings, home and auto savings, or non-retirement investment accounts, or any other savings, including saving without a specific goal) and (or) into periodic donations to charity.

Uniquely, the present invention allows a three-way simultaneous transaction of funds by the user: 1) a purchase, 2) a charitable donation, and 3) a retirement or other saving investment.

In use, the user will sign up for the service and preauthorize the numerous micro-tax payments which will be withdrawn from their normal checking/working bank account. In addition, in preferred embodiments they will set up a “sweep” account in a fiduciary institution for use during the process of donation. The user will also arrange the settings of their transfers, select their charity of choice and so on.

One important component of the invention is a mobile device app (or a web site) through which the user can access their service account, change settings related to donations, and so on. This app enables another important functionality: the app may, with the user's permission, mine additional data about transactions the user makes: GPS location, searches the user carried out prior to the purchase, and so on and so forth.

Importantly, the user may join a social media network which relates to their charitable giving. For example, a user might select the religious institution which they attend as their charity of choice, or another benevolent organization to which they belong, or just carry out the social media aspect of the invention through their regular social media outlet, without further differentiation. The social media community can then manually post, or the device of the invention can automatically post, updates about their charitable giving.

The present invention furthermore teaches that a user may create a group with a group saving or group donation activity. This user-created group may have rules for micro-self-taxing of each member for a combined effort. This ability to create a group saving effort based upon individual spending is a solution to a technological problem the banking system has never before solved.

Even further, the invention allows a new type of analysis of a user's financial health, a financial health matrix or financial health score. The financial health matrix/score is based upon a multi-dimensional analysis of a user's spending habits, such as how much money do they save and in what ways they save, how much to they donate and in what ways, and not just what they spend money on but what spending habits are indicated by the spending history the user develops. This financial health matrix score is essentially un-related to a traditional credit rating (which measures only credit-worthiness), and is also much different than a traditional list of places and products which a user frequents. Such older mechanisms are directed specifically to short term marketing: should a user receive a home loan, or what advertisement to display to a user. The financial health matrix on the other hand builds up a multi-dimensional understanding of a user's ways of thinking and behaving, what motivates the user to save and what motivates the user to donate, what mental habits lead to the observed spending and so forth.

While the financial health matrix allows the computer to carry out functions which it has never done before, the financial health score is itself just a springboard to allowing the banking system, server computer and user device to do other more advanced functions. The system can guide saving, spending and donations by the user through a better understanding of the user provided by the holistic financial health matrix/score. The user can designate not just three buckets for money to flow to (spending, saving, donations) but can further designate multiple different end accounts (that is, saving to multiple different investments, donating to several different charities and so forth).

Yet further, the multi-dimensional financial health score of the invention allows location based opportunities to be presented, which opportunities may not be advertised (for example, a notification about a charity event happening near the user which event did not advertise, a sale which was not advertised to the user but which is relevant to the user's financial health score, as in the example above.

The financial solution presented herein has a web site, a mobile application, and a back-end processing engine, the digital DNA gateway. These three components are unique, each offering different functionality to the consumer.

On the website, the consumer can (1) access research and educational materials, (2) utilize tools, widgets and calculators, (3) setup and manage their user profile, (4) reporting and administration, (4) download the mobile application, and (5) make purchases through our affiliate program.

The mobile application will provide (1) profile setup and management, (2) access to financial accounts, charitable organizations and payment processing engines, (3) an engaging user experience that provides immediate feedback on the social impact of a user's giving and saving behaviors, (4) tracking and reporting so the user at any time knows how much they have donated or saved toward their goal(s), (5) present targeted consumer offers based on spending, giving and savings decisions, thereby offering consumers additional value for things they are already purchasing, and (6) year-end summary information and tax reporting to make it extremely simple for users to get this information and prepare their taxes.

The digital DNA gateway (DDG) will be a major part of the system, connecting to both the web site and mobile application. The DDG will (1) manage security, (2) enable connectivity to third party charitable organizations and financial institutions, (3) perform data analysis and calculations, (4) store all user data, (5) provide connectivity to payment processing engines, and (6) facilitate the three-way financial transaction of giving and saving based on daily spending patterns. The DDG will be highly secure, utilizing multi-factor authentication, encryption, and advanced forms of user security such as fingerprint and/or facial recognition.

### Summary in Reference to Claims

A method of self-taxing for savings and charitable donations by a consumer/payer having a checking account in at least one payer bank, in a banking system having: retailers/payees, a payee bank, a charity, at least one transaction data aggregator, and an ACH system for settlement; such payer also having a savings account, the method comprising the steps of:

such payer authorizing such payee to receive a payment; having an amount and having transaction data;

such payee requesting the payment via such payee bank;

such payee bank transmitting via such ACH system such request for the payment to such payer bank;

such payer bank transmitting via such ACH system the payment to such payee bank;

such payer bank reporting the payment to such payer and such payee bank reporting the payment to such payee;

in accordance with a preauthorization from such payer, reporting the payment to a self-taxing bank institution, the preauthorization comprising a table of rules;

the self-taxing bank institution, also in accordance with the preauthorization, initiating a transfer of a first amount of money from such payer's checking account at such payer's bank to a first sweep account set up with the consent of such payer and initiating an additional transfer of a second amount of money from such payer's checking account at such payer's bank to the first sweep account;

when a first threshold is reached, transferring a first amount of money from the first sweep account to a recipient;

when a second threshold is reached, transferring a second amount of money from the first sweep account to a second recipient;

using the transaction data, the preauthorization table of rules, the first amount of money and the second amount of money, updating a financial health score, the financial health score comprising a matrix of information about the financial health of the payer, including their spending habits, their transfers to the first recipient and their transfers to the second recipient.

It is therefore yet another aspect, advantage, objective and embodiment of the invention to provide a method of self-taxing for use by a second consumer/payer for savings and charitable donations, with a second payee and a second payer bank and a second payee bank, the method further comprising:

such second payer authorizing such second payee to receive a second payment; having a second amount and having second transaction data;

such second payee requesting the second payment via such second payee bank;

such second payee bank transmitting via such ACH system such request for the second payment to such second payer bank;

such second payer bank transmitting via such ACH system the second payment to such second payee bank;

such second payer bank reporting the second payment to such second payer and such second payee bank reporting the second payment to such second payee;

in accordance with a second preauthorization from such second payer, reporting the second payment to a second self-taxing bank institution, the second preauthorization comprising a second table of rules;

the second self-taxing bank institution, also in accordance with the second preauthorization, initiating a transfer of a third amount of money from such second payer's checking account at such second payer's bank to the FIRST sweep account set up with the consent of such FIRST payer and initiating an additional transfer of a fourth amount of money from such second payer's checking account at such second payer's bank to the FIRST sweep account;

whereby such third and fourth amounts of money of such second user are going to the same FIRST sweep account as the first and second amounts of money of such first user.

It is therefore yet another aspect, advantage, objective and embodiment of the invention to provide a method of self-taxing further comprising: the financial health score is in turn provided to a data marketer.

It is therefore another aspect, advantage, objective and embodiment of the invention, in addition to those discussed previously, to provide a method of self-taxing for savings and charitable donations by a consumer/payer having a checking account in at least one payer bank, in a banking system having: retailers/payees, a payee bank, a charity, at least one transaction data aggregator, and an ACH system for settlement; such payer also having a savings account, the method comprising the steps of:
1) such payer authorizing such payee to receive a payment; having an amount and having transaction data;
2) such payee requesting the payment via such payee bank;
3) such payee bank transmitting via such ACH system such request for the payment to such payer bank;
4) such payer bank transmitting via such ACH system the payment to such payee bank;
5) such payer bank reporting the payment to such payer and such payee bank reporting the payment to such payee;
6) the payer bank, in accordance with a preauthorization from such payer, reporting the payment to a self-taxing bank institution;
7) the self-taxing bank institution, also in accordance with the preauthorization, initiating a transfer of a first amount of money from such payer's checking account at such payer's bank to a sweep account set up with the consent of such payer;
8) when a first threshold is reached, transferring a first amount of money from the sweep account to a recipient.

It is therefore yet another aspect, advantage, objective and embodiment of the invention to provide a method of self-taxing further comprising:

at step 7, and again in accordance with the preauthorization, initiating an additional transfer of a second amount of money from such payer's checking account at such payer's bank to the sweep account;

when a second threshold is reached, transferring a second amount of money from the sweep account to a second recipient.

It is therefore yet another aspect, advantage, objective and embodiment of the invention to provide a method of self-taxing wherein:

the recipient is one member selected from the group consisting of: such payer saving account, and a charitable organization.

It is therefore yet another aspect, advantage, objective and embodiment of the invention to provide a method of self-taxing wherein the first recipient is such payer saving account and the second recipient is a charitable organization.

It is therefore yet another aspect, advantage, objective and embodiment of the invention to provide a method of self-taxing wherein the first threshold is one member selected from the group consisting of: a set time, a set amount of money, and combinations thereof.

It is therefore yet another aspect, advantage, objective and embodiment of the invention to provide a method of self-taxing, wherein the sweep account is set up at one member selected from the group consisting of: the self-taxing bank institution, such payer's bank, a fourth bank institution affiliated with the self-taxing bank institution, and combinations thereof.

It is therefore yet another aspect, advantage, objective and embodiment of the invention to provide a method of self-taxing, wherein the self-taxing bank institution offers and the payer may select, the first amount of money from a group consisting of: a percentage of the amount of the payment, rounding each transaction up to the next whole dollar amount, a fixed dollar amount for every transaction, and combinations thereof.

It is therefore yet another objective, aspect, advantage, and embodiment of the invention to provide a method of self-taxing wherein the notification of step 6 occurs via such transaction data aggregator.

It is therefore yet another aspect, advantage, objective and embodiment of the invention to provide a method of self-taxing wherein the transfer of money from the payer's checking account is also an ACH transaction.

It is therefore yet another aspect, advantage, objective and embodiment of the invention to provide a method of self-taxing further comprising the step of:
9) aggregating data from each transaction into a database associated with such payer. It is therefore yet another aspect, advantage, objective and embodiment of the invention to provide a method of self-taxing, further comprising the step of:
10) offering to such payer an app module for use on a mobile device owned by such payer;

the app module operative to provide to such payer reports on their transfers, account balances, and transfer preauthorization settings; the app module further operative to provide to such payer the option to alter transfer preauthorization settings, alter the first threshold, perform banking functions, and authorize the payment.

It is therefore yet another advantage, objective and embodiment of the invention to provide a method of self-taxing wherein the app module is further operative gather additional data about such payment and aggregate such additional data into the database associated with such payer, the additional data comprising one member selected from the group consisting of: the transaction data, GPS data, data regarding a recent search made on the mobile device using an online search engine, and combinations thereof.

It is therefore yet another aspect, advantage, objective and embodiment of the invention to provide a method of self-taxing in which there are other payers using the self-taxing method, further comprising the steps of:
11) offering to such payer the opportunity to participate in a social media network relevant to the charitable institution;

wherein the app module is further operative to make the offer, receive feeds from the social media network regarding activities of such other payers, offer to such payer the opportunity to post to the social media network their own activities, automatically post to the social network, receive notifications from such payees, offer to such payer the opportunity to post to the social media network their own transfer-related activities, automatically post to the social network such payer's transfer related activities, and combinations thereof.

### BRIEF DESCRIPTION OF THE DRAWINGS

FIG. 1 is an extremely simplified block diagram overview of the activity of the invention, which will be expanded upon in later diagrams.

FIG. 2 is a simplified flow chart of the activity of the invention, expanded upon in later diagrams.

FIG. 3 is a simplified block diagram of the best mode now contemplated and the presently preferred embodiment for carrying out the invention.

FIG. 4 is a block diagram of a data structure used for the data mining aspect of the present invention.

FIG. 5 is a block diagram of the customer-oriented parts of the overall electronic ecosystem of the invention.

FIG. 6 is a very general block diagram of the modules of the core operations of the invention.

FIG. 7 is an in-depth block diagram of the transactional details of the inventions operations, showing flows of payments and reports in the financial system.

FIG. 8 is a block diagram of the major parts of the invention in terms of structure, functions and modules.

INDEX TO REFERENCE NUMERALS

| | |
|---|---|
| Customer/donator/saver | 102 |
| Seller | 104 |
| Transfer of money (payment) | 106 |
| Transfer of money (saving) | 108 |
| Transfer of money (donation) | 110 |
| Bank | 112 |
| Charity | 114 |
| Purchase | 202 |
| Collect data | 204 |
| Aggregate data to database | 206 |
| Transfer to retirement savings | 208 |
| Transfer to sweep account for charity | 210 |
| Charity threshold? | 212 |
| Transfer to charity from sweep account | 214 |
| Transaction | (A) |
| Scrape financial data | (B) |
| Inform invention server | (C) |
| Apply user goals | (D) |
| Charity/saving transaction ordered to ACH | (E) |
| Transfer to savings | (F) |
| Transfer to third party donor-advised fund | (G) |
| Transfer to charity (after threshold) | (H) |
| Transfer to fund admin | (I) |
| Transfer to invention admin | (I) |
| Account aggregator | 302 |
| Invention charity/saving admin | 304 |
| ACH processor for charity/saving | 306 |
| Sweep fund/3^{rd} party donor-advised fund | 308 |
| Charity | 310 |
| 3^{rd} party nonprofit platform admin | 312 |
| Invention admin | 314 |
| Data structure/object | 400 |
| Consumer name & ID data | 402 |
| Merchant name and ID data | 404 |
| Date and time data | 406 |
| Product data (if member card used) | 408 |
| Purchase amount data | 410 |
| GPS data (optional) | 412 |
| “User searched retailer on device” flag | 414 |
| “User searched on device for product” flag | 416 |
| Search data | 418 |
| User-side ecosystem | 500 |
| User mobile device | 502 |
| User desktop device/website | 504 |
| Network | 506 |
| Social media | 508 |
| Admin device | 510 |
| Server | 512 |
| Connection to financial services/network | 514 |
| App server (NV memory) | 600 |
| Consumer web/app support modules | 602 |
| Admin support modules | 604 |
| Core ops module | 606 |
| Payment connection modules | 608 |
| Chinese wall | 610 |
| Reporting management module | 612 |
| Transaction database management module | 614 |
| Database | 616 |
| Detailed financial flow | 700 |
| Consumer/user | 702 |
| Retailer/originator | 704 |
| Originator bank | 706 |
| ACH system | 708 |
| Receiver (consumer) bank/authorized bank | 710 |
| Checking | 712 |
| Retirement savings/other savings | 714 |
| Data aggregator | 716 |
| LGS bank functionality | 718 |
| Database | 720 |
| Charity bucket/sweep account | 722 |
| Saving account/retirement account | 724 |
| Charity | 726 |
| Mobile App | 802 |
| Web App | 804 |
| Core API Services | 806 |
| User related services | 808 |
| Account related services | 810 |
| Payment related services | 812 |
| Transaction related services | 814 |
| Core engine | 816 |
| Data management services | 818 |
| Data hub | 820 |
| Charity services | 822 |
| Global cloud infrastructure | 824 |
| Enterprise services | 826 |
| Enterprise systems | 828 |
| DNA Gateway | 830 |
| Partners | 832 |
| Account aggregator | 834 |
| Financial services provider | 836 |
| Charity Aggregator | 838 |
| Product transfer | 1 |
| Payment (an authorization) | 2 |
| Request to ODFI 706 | 3 |
| Request to ACH 708 | 4 |
| Request to RDFI 710 | 5 |
| Payment via ACH | 6.0 |
| Report to consumer 702 | 6.1 |
| Report to data aggregator 716 | 6.2 |
| Report to LGS bank 718 | 6.3 |
| Payment from ACH | 7 |
| Report of payment | 8 |
| (Additional ACH transaction process) | 9 |
| Transfer from sweep savings to consumer savings | 10 |
| Transfer from sweep account to charity | 11 |

### DETAILED DESCRIPTION

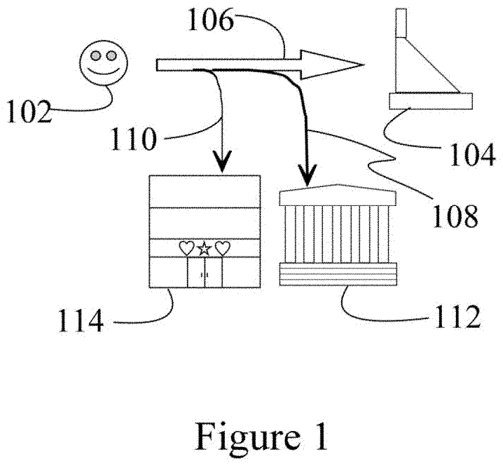

FIG. 1 is an extremely simplified block diagram overview of the activity of the invention, which will be expanded upon in later diagrams. Customer/donator/saver 102 will have this perspective on the operations of the method and financial transactions of the service. User 102 makes a purchase or otherwise pays/sends money to seller 104. Out of this larger sum of money, or more accurately, added on top of that amount of money, two much smaller transfers of money are made. These micro-self-taxes may be a set amount of money, or may simply round up the purchase price to the next dollar, or they may be a fixed percentage of the purchase price, for example, 5%. The first transfer of money (normal payment) 106 will include a donation 110 and a transfer of money to a savings account 108. (Such savings accounts can be normal savings, retirement, investment, health, or any other type of account.)

Note that either the transfer of money (to savings) 108 or the transfer of money (for a donation) 110 may be omitted at the user's discretion, however, it is anticipated that those persons interested enough to sign up for the service will also be interested in doing both.

From the user's perspective, the bank having the savings/investment account will in due course receive a transfer of funds (108) and the charity will receive a transfer of funds (110). Note that there may be thresholds, in order to protect charity institutions. In particular, it is probably desirable that the micro-transfers to charity (which might be a few cents individually) be accumulated until a reasonable threshold is reached (for example, something like 50$ or the like), and then the charity receives a single donation. The same principle may be applied to the savings transfers as well.

The provider of the invention may strategically associate with banking institutions (including credit unions) to provide savings products in a wide range, so the user may elect to keep their saving account in their own presently utilized financial institution, or may place the new savings account out with a different financial institution (F.I.).

Note that while in the presently preferred embodiment and best mode now contemplated the transfer to savings 108 is a retirement account, in alternative embodiments the savings may be other savings accounts for other purposes such as health saving accounts, college savings, trip savings, home and auto savings, or non-retirement investment accounts, or any other savings, including saving without a specific goal. Importantly the invention can be used to invest in paying off debt, such as student loans, home and auto, consumer debt and so on.

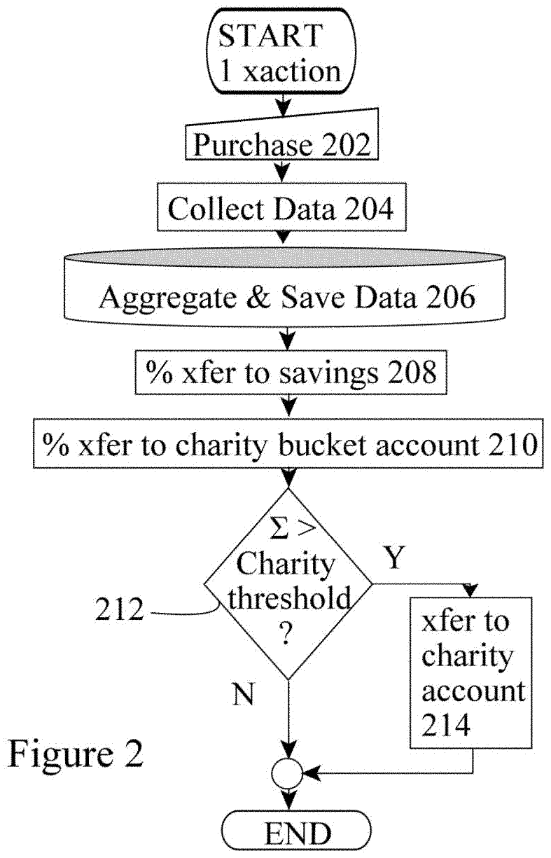

FIG. 2 is a simplified flow chart of the activity of the invention, expanded upon in later diagrams. Purchase step 202 involves the payer (customer) authorizing the seller to receive money from their bank account. During the transfer of funds after the authorization, data on the transaction (usually buyer, seller, and amount is all that the banking system itself picks up) is gathered in step 204, collect data. This individual purchase data is then aggregated to the database at step 206, thus creating an enormous database of purchase data for later usage or sale.

Eventually or immediately, a bank transfer of money from checking to savings (208) leads to a small saving transaction occurring automatically, without the buyer's active initiation. In addition, a transfer of funds from the checking account of the user to a sweep account, where it is held for charity (210) is made. When the charity threshold (a certain amount of money, or perhaps a certain amount of time, a number of transactions, etc) is reached (tested at step 212), then the actual transfer to the charity from the sweep account (step 214) takes place.

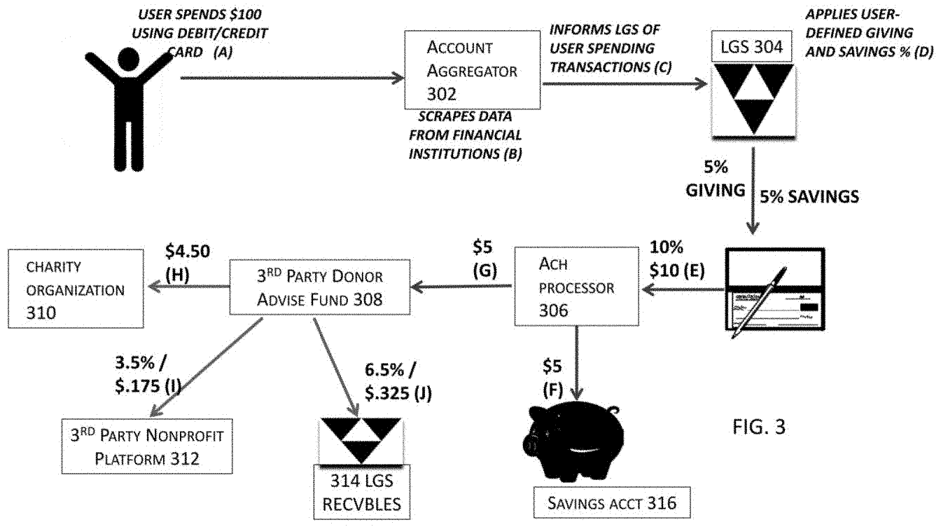

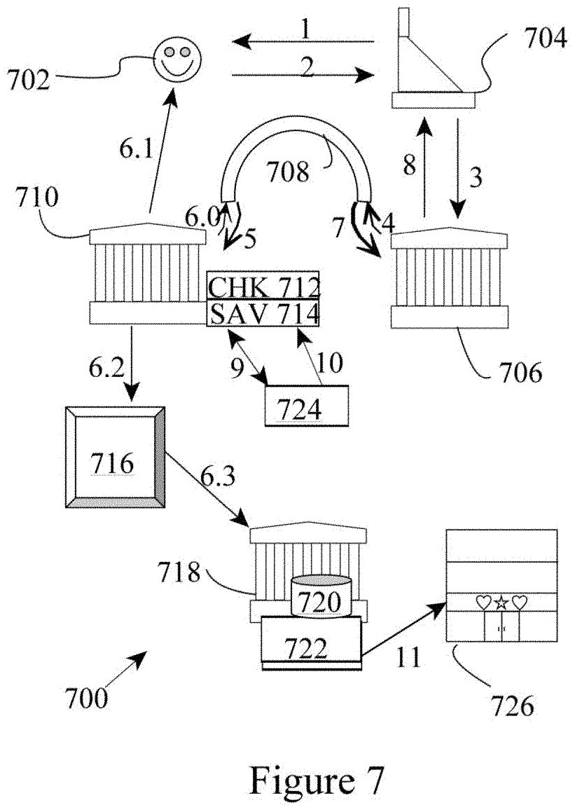

FIG. 3 is a simplified block diagram of the best mode now contemplated and the presently preferred embodiment for carrying out the invention. Note that this is in contrast to FIG. 7, which focuses more on the traditional payment/settlement system and is now merely an alternative embodiment. FIG. 3 shows not only the preferred embodiment but also the steps of an exemplary transaction.

In FIG. 3, step (A) is a user spending 100$ (the amount is chosen for convenience of the example). In this presently preferred embodiment, an account aggregator 302 carries out step (B), the scraping of transaction data from financial institutions with which the user has relationships (accounts). Hypothetically, the user could be signed up at a single account, however, in the best mode now contemplated the aggregator 302 allows usage of as many accounts, credit cards, etc, as the user may desire. The aggregator will scrape all known accounts for use and then carry out the rest of the steps of the invention on all transactions in those accounts, if that is what the user has specified as their goal. (Note that the user may specify only some accounts, or some financial institutions or certain types of transactions, which may be included/excluded from use.)

When aggregator 302 has found a spending transaction by the user, the aggregator will inform the invention system 304 (the server system/cloud system at the heart of the present invention) of the transaction so that micro-self-taxing may commence. In particular the invention (LGS) system 304 will apply user defined goals for giving and saving (step D) to the transaction. In the example embedded within this figure, the user has specified a 5% charitable giving rate and also a 5% savings rate. The total of 10% is then withdrawn (E) from the user's checking account (in this case a checking account, but other account types are possible).

ACH processor 306 will then carry out the savings and charity portions of the transaction. Note that presumably another ACH processor or other settlement method is occurring for the underlying ($100 in this example) transaction, however, the server 304 of the invention is in charge of initiating the two transactions (G) and (F) of the giving and saving. (This presently preferred system is in contrast to the alternative discussed later in regard to FIG. 7.) Savings account 316 receives one payment directly, (F).

Payment (G) goes into a third-party donor-advised fund 308. This fund 308 is advised or managed by a third-party non-profit platform (312). It functions as a sweep account or sweep account. In this case the 5$ donation is typical of the micro-transactions which will go into the advised/sweep fund 308, and this small size is not only key to the invention but also is a cause for concern to the final charity recipients 310. In particular, the charities might have a more difficult time managing a multitude of tiny deposits/gifts. To avoid this problem, the third-party donor advised sweep fund 308 simply accumulates monies received until a suitable threshold is reached (for example, and presently preferred, a time threshold of one month, however it could be a threshold of amount (example: 50$ or 1000$, etc) or another threshold measurement). At the end of one month, money from the account 308 is transferred three ways: the bulk goes to the final charity organization 310, but two tiny amounts go to overhead. In this case the original purchase was 100$, the charity donation was 5$, and 3.5% of the charity donation (in this case $0.175 (17 cents) or 17.5 ten thousandths of the original transaction) go to the administration of the third party platform 312 and a similar miniscule amount (6.5% of the charity donation, $0.325 (32 cents) or 32.5 ten thousandths of the original transaction) go to the invention administration 314.

Thus, the invention is not only capable of providing charities with a massive infusion of giving but it also is self-sufficient, so that operations can continue long term.

In addition, the present invention allows creation of group efforts under the control of the individual users. For example, a family might combine to save up for a special vacation or to communally donate to a particular good cause. This is a technological problem which banking systems have been unable to solve up until now, much like the use of a multi-dimensional financial health score allows the system to do things never done before.

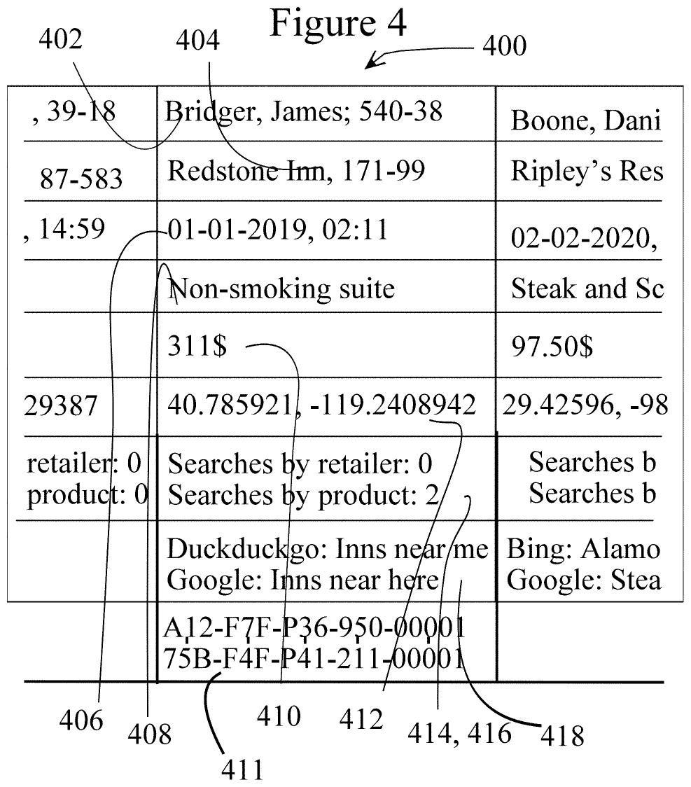

FIG. 4 is a block diagram of a data structure used for the data mining aspect of the present invention. Data structure/object 400 is in this case a single transaction record, organized around a few low-level data fields. In practice, transaction records include all four types listed above and can be organized in numerous different ways. Types of data fields can be quite flexible and numerous possible implantations can be used in different embodiments of the invention.

Consumer name & ID data 402 identifies the customer/payer/donor, while merchant name and ID data 404 identifies the merchant in the transaction. In alternative embodiments this data is not needed, however, since the assembly of a valuable database of consumer behavior is a secondary goal of the invention, the merchant ID data in each transaction is definitely desirable and is thus the best mode presently contemplated and presently preferred embodiment of the invention.

Date and time data 406 are aggregated as well, for the same reason, and if the customer uses a member card (such as a store card or the like), then with the cooperation of retailers it may in alternative embodiments be possible to acquire actual product data 408, such as whether a person bought a steak dinner or rented a hotel room.

Purchase amount data 410 is obviously part of the core ACH dataset as well.

However, mobile devices provide exciting possibilities for further enhancement of the dataset. With the customer's prior permission, the mobile device might capture GPS or network geographic data, such as latitude and longitude data 412. This, combined with time data 406, would pinpoint the location of the mobile device when the purchaser made the purchase, even if the mobile device itself was in no way used in the purchase. In addition to GPS data 412, user searches leading up to the purchase might be collected as well. If a user searched for “Steak houses near the Alamo” or “Inns in the Black Rock desert”, during some short period of time prior to making a purchase, the search data might be useful as well. Thus flags 414, 416 (“User searched retailer on device” and “User searched on device for product”) might be set, and combined with actual search data 418, provide a very deep wealth of knowledge about the consumer.

The financial health matrix/score 411 is based upon a multi-dimensional analysis of a user's spending habits, and is NOT a simple credit worthiness score, nor is it a list of expenditures. It includes items such as how much money do they save as a percentage of income and raw amount and in what ways they save, invest, and use their saving, when they save (after period irregular payments, every month, every expenditure, etc), and the same information for how much they donate and in what ways, and not just what they spend money on but what spending priorities and habits are indicated by the spending history the user develops. This financial health matrix score 411 is essentially un-related to a traditional credit rating (which measures only credit-worthiness), or might incorporate as a single element of a much larger matrix a credit rating, and is also much different than a traditional list of places and products which a user frequents. Such older mechanisms are directed specifically to short term marketing: should a user receive a home loan, or what advertisement to display to a user. The present invention allows much more targeted marketing: not just “pop music” but “pop music with upbeat tempos and positive social messaging.” The financial health matrix thus builds up a multi-dimensional understanding of a user's ways of thinking and behaving, what motivates the user to save and what motivates the user to donate, what mental habits lead to the observed spending and so forth. As an example, traditional spending habit lists showing that a user buys old fashioned music on vinyl discs (records) would advertise more records to the user. But the multi-dimensional financial health matrix of the invention might show that the user buys records for a certain type of charitable cause, that the user has a monthly budget for this activity which monthly budget is actually based on a calculation of disposable income for that month and how recently the user received income, and the records purchased have a certain limiting factor in terms of being a certain age, for example, original discs from the 1940s but not from later eras and not reprints. A traditional list of good purchased might catch some of these habits such as the type of discs purchased, but would certainly miss the relationship to recent income and the calculation of momentary disposable income, while a traditional credit score would actually pick up NO useful information about this habit.

While the financial health matrix 411 allows the computer to carry out functions which it has never done before, the financial health score is itself just a springboard to allowing the banking system, server computer and user device to do other more advanced functions. The system can guide saving, spending and donations by the user through a better understanding of the user provided by the holistic financial health matrix/score. The user can designate not just three buckets for money to flow to (spending, saving, donations) but can further designate multiple different end accounts (that is, saving to multiple different investments, donating to several different charities and so forth). Yet further, the multi-dimensional financial health score of the invention allows location based opportunities to be presented, which opportunities may not be advertised (for example, a notification about a charity event happening near the user which event did not advertise, a sale which was not advertised to the user but which is relevant to the user's financial health score, as in the example above.

Note that field 411 is depicted as a two-dimensional array of limited elements in a hexadecimal or alpha mode but it is not so limited. The array becomes much more powerful as additional dimensions are added. An “N” dimensional array being even more powerful.

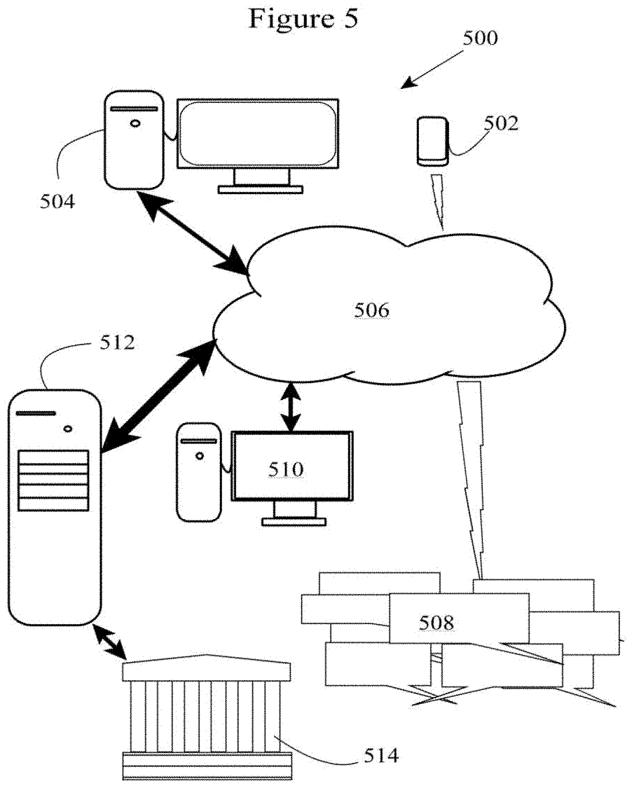

FIG. 5 is a block diagram of the customer-oriented parts of the overall electronic ecosystem of the invention. User-side ecosystem 500 features the user mobile device 502 (having the app 302 (FIG. 3)) running thereon, user desktop browser device 504 (with the web site 304 running thereon), and a network 506 of any type now known or later devised which connects the user owned devices to the broader electronic world.

Social media 508 is a very important part of the invention/a very important part of the environment in which the invention operates. By the use of social media, customers can feel a greater sense of connection to their charity and their friends, family and co-workers. For example, a user might post, “Hey, I just joined the app for giving to First Reformed Church here in town! Everyone should try this, it's so easy to make a difference!” In embodiments, the system might prompt the user and offer to autopost, or even automatically post without input, messages like “I made my personal goal of giving for this month. And did it by buying myself a sweater!” The usage of the social media network however can extend far beyond these simple examples.

This social media 508 has a second important benefit for the monetization of the system. By adding the social media data on each consumer to the purchase, charity, and investment data on the consumer, a very comprehensive database of consumer information can be built up quickly.

Admin device 510 allows the control over the entire system from an HQ standpoint, regardless of location, while server 512 may provide the actual host for the digital DNA gateway and core programming, the accumulating database of customer transaction data, and so forth.

Connection to financial services/networks 514 is a carefully controlled access to the actual ACH or other banking networks for the carrying out of the actual micro-transfers of funds between accounts.

Thus, the invention operates, in the viewpoint of the consumer, in a connected network, with financial elements, social networks, and stored information about the customer's goals, accounts, and preferences.

### Summary of Structure/Modules

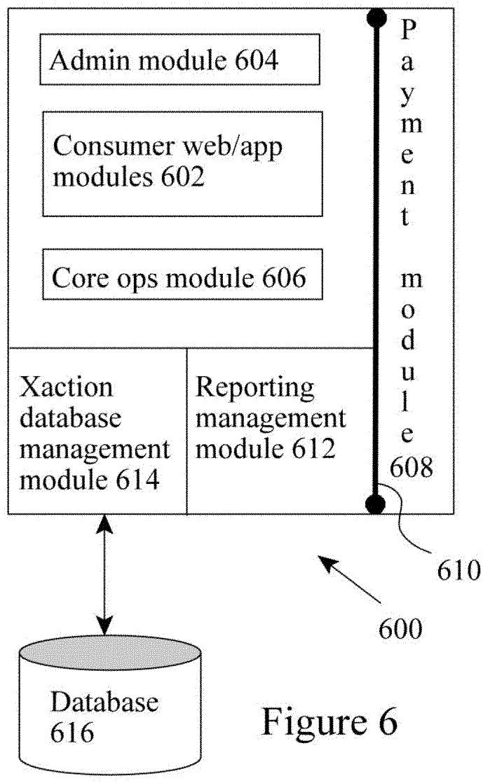

FIG. 6 is a quite general block diagram of the modules of the core operations of the invention. App server 600 has non-volatile computer memory and a CPU or processor unit. The memory may contain the various modules of the invention, such as the detailed listing in FIG. 3, or more generally speaking, consumer web/app support modules 602, admin support modules 604, core ops module 606, payment connection modules 608 located behind a compliant security system (“Chinese wall”) 610 including anti-access software, firewalls, security and so on.

Reporting management module 612 handles the numerous and varied types of reports issued (to almost every type of stakeholder in the financial transfer system of the invention), and transaction database management module 614 controls and aggregates to database 616.

In more detail, the functional elements of the present invention, expanded upon in later diagrams, may be summarized as follows. The overall electronic system may have several elements to it, including a mobile app for devices such as iOS, Android, or Windows cell phones, pods, pads, tablets, phablets and the like. It may also have a desktop app for devices such as PCs, Apple computers and the like.

During the course of everyday transactions, the user will be notified of the following: a) when a micro give transaction is initiated, the user will be notified of the impact of that transaction based on the nature of the donation or the purpose for saving. For example, if the donation is going to a specific cause driven by a specific charitable organization, then the user will be notified of the impact their contribution has to that cause, b) when a micro-save transaction is initiated, the user will be notified of the impact toward their goal of that transaction based on the savings goal they have established, c) periodically, the user will be notified of the broader impact of the larger micro-self-taxing community. This could include notifications related to specific charitable organizations, or to specific charitable causes, or to the broader impact of users saving for their future, and d) progress toward goals and recommendations based on user preferences and behaviors. In addition, other notification may be provided.

Users will have the option to specify savings goals they are trying to accomplish. This will be expressed in the form of savings goals for retirement (qualified) or savings goals for something like a new car or a home down payment (non-qualified). The user will be able to self-configure the goal to match their personal situation.

A desktop browser to a web site provides similar functionality in the desktop PC (Mac, Chromebook) setting.

Either way, the user may set the parameters of their donations and savings, for example, choosing a savings rate of 3% and a donation rate of 4%, or setting the donations/transfers to being “round up” purchases to the next whole dollar (so if a transaction is $54.88, the transfer would be an extra $0.12, bringing the transaction to an even $55), or just a set amount per transaction, such as $1 per transaction.

A Digital DNA gateway is central to the system: it provides standard services/API connections, transaction services, payment services, calculations, analytics and core ops, and of course external connectivity to charitable organizations, financial organizations, transaction aggregators, charity aggregators and so on. For example, at the set up phase of a new customer's account with the service of the invention, the external connectivity functionality might point the new customer to a charity aggregator which lists almost every charity in the US and allows the customer to search for their own unique choice of charity: by partnering with charity aggregators, it is possible to offer single point searches among over 2 million US charities and even more world-wide.

Note that in the presently preferred embodiment, it may be preferable to move most computation cycles from the mobile devices (which typically feature smaller ARM RISC processors) to the gateway, which with the advantages of distributed server technology can have nearly infinite processing power on demand. However, in alternative embodiments, the mobile devices may handle more of the load, particularly if the power of such device CPUs continues to increase more and more closely to desktop/server capabilities.

Management, analytics, and intelligence modules identity and access management modules, and master Record Data (dB entry) are necessary modules for continued functioning of the system. Note that the master record data breaks down several more ways: consumer records, transaction records (for which an example is provided in FIG. 4), charitable organization records and financial institution records.

In addition, note that other functionality may be provided which supports charitable organizations in the architecture, which allows financial institutions entry into the invention and so on.

Cloud infrastructure allows extremely distributed functionality to be emplaced in a wide range of geographic and electronic locations, adding to speed of access and function and increasing system redundancy on many levels.

### End of Summary of Structure/Modules

FIG. 7 is an alternative embodiment rather than the preferred embodiment showing one hypothetical in-depth block diagram of transactional details of the invention's operations, showing flows of payments and reports in the financial system. Note that while this chart is fairly complicated, in fact it is actually a simplification of some aspects of the financial network. This system uses an alternative financing flow when compared to the embodiment discussed previously, making more use of the traditional banking/settlement system. Detailed financial flow 700 starts with the consumer/user 702 and their purchase transaction 1 with retailer/originator 704, which payment 2 proceeds through 3 the originator bank 706 (such as the retailer's merchant account, their bank and so on).

ACH system 708 then receives the request 4 from the ODFI, and passes it 5 to the RDFI, the customer's bank 710 (also called the receiver (consumer) bank/authorized bank).

Up to this point, most processing is as normally handled. However, now reporting becomes more complicated in order to handle the micro-transfers of the invention. Either bank 710, or the service functionality 718 instead, will send the normal payment 6.0 via ACH 708, and will report payment to the consumer (6.1), as well as a report (6.2) to a data aggregator (716) (who probably actually has this information by other means in any case), and a report 6.3 to the service provider 718. The payment sent will come normally from checking 712 (or possibly savings 714), thence to and from the ACH (7) and a report of payment (8) is made as normal to the seller. However, the provider of the functionality of the invention 718 will also enter the transaction into database 720, begin a transfer into the bucket/sweep account 722 (for the money destined for the charity 726), and initiate a micro-savings-transfer to savings account 724, which as mentioned may actually be account 714 or a different account. Note that at this point additional ACH transaction processes 9 are quite likely, for example, to/from accounts 724/714, etc, but this ACH process is quite similar to the overall one and will be omitted for the sake of clarity of this diagram.

As noted previously this is not the presently preferred embodiment of the invention.

Transfer from LGS savings to consumer savings 10 is thus one possibility. Also, the transfer from the provided sweep account 722 to charity 726 (11) will await fulfillment of the threshold value set by the customer at the time of setting up their service.

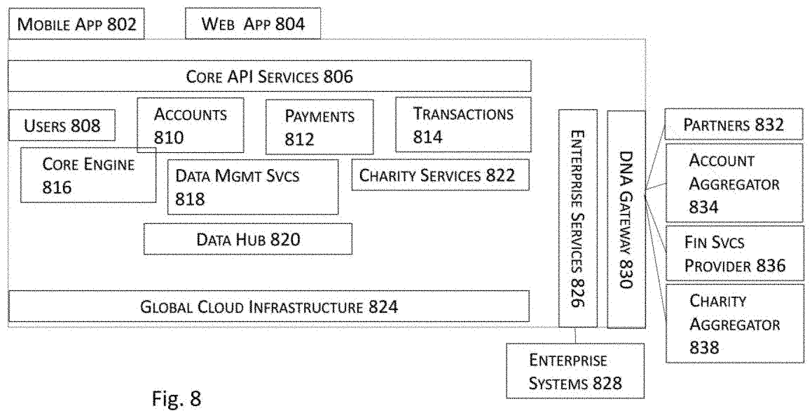

FIG. 8 is a block diagram of the major parts of the invention in terms of structure, functions and modules.

Mobile App 802 will allow a user to sign up, register accounts, set their goals, provide social media connections and otherwise manage their own micro-self-taxing, micro-self-saving, micro-giving account from their mobile device such as a phone or tablet. Web App 804 allows a user the same wide range of functionality and capability on the internet.

Core API Services 806 are those services provided by the server (or cloud) which support the web app 804 and the mobile app 802, thus these are the server-side functions of the app/application which the user sees and controls. These obviously also provide memory and module management, security, and similar functionality.

User related services 808 are more specifically the services related to the user as a person: security and log-in, preferences, and so on and so forth. On the other hand, account related services 810 are those modules, functions and services which support management of the various financial accounts of the user, that is, functionality to support adding financial accounts to the overall micro-self-taxing-saving-giving account (for example, when a user gets a new credit card and registers (“links”) that card into the micro-self-taxing-saving-giving system), or conversely to deregister (de-link) an account (for example for a lost or expired credit card etc). Importantly, these services will include on which allows a user to set their goals for giving and investment. These goals may include: what percentage should be added to transactions to give to charity and another percentage for saving, what the destination of the saving percentage will be (there are numerous types of investments, ranging from simple saving accounts to retirement accounts, life insurance accounts, investment funds, mutual funds and so on and so forth: the type of investments which the invention can contribute to is limited only by the rules of the target investments, not by the present invention). This can include what types of transactions will be micro-self-taxed, for example purchases but not the grocery store, or purchases made manually but not automated deductions, or online but not in person, and so on. In addition, in some cases the user might set threshold levels, notification options, social media options and more.

Payment related services 812 support the user's making transfers of the money they have micro-self-taxed-given-saved: this includes scraping (detecting) information that a regular transaction such as a purchase has occurred (which will be handled by the regular banking system), informing the invention server that the transaction has occurred, and facilitating the numerous transfers seen previously in FIG. 3.

Transaction related services 814 of course will deal with the actual base transactions themselves, handling the low-level details of card swipes, PIN verification and so on.

Core engine 816, the kernel of the operations of the invention, may be considered to supervise the operation of the overall system. These core operations will keep the system overall functioning, and naturally includes calling the various other services shown herein as necessary.

Data management services 818 control flow of data, I/O, and control the actual operation of the data hub 820, which itself may be as simple as a storage media or distributed redundant array of devices or as complex as a cloud based widely distributed architecture.

Charity services 822 are those functions which support use of the invention by charity organizations, who obviously may wish to register with the invention as either recipients, or as users (donors), or in other capacities as partners, etc. Thus charity services 822 could include another web app similar to web app 804 but geared to the needs of charities, or it could include different account services and so on.

Global cloud infrastructure 824 essentially is the group of services supporting use of/by the hosting engine of the present invention, that is, the server.

Enterprise services 826 is a communication function which services support the application of the present invention connecting and communicating with enterprise systems: CRL, financial systems, etc, that is, communicating with the enterprise systems 828 depicted connecting with the enterprise services 826.

DNA Gateway 830 provides the proprietary gateway for partners 832 of the present invention organization to provide services of the present invention. Thus, a partner might offer the present invention in much the same way that a bank or credit union might offer a credit card branded VISA® account or the same bank or credit union might offer QuickBooks® tax software. Partners of the present invention could obviously include banks/credit unions and other financial institutions such as 836, who might offer their users, when the user logs onto the bank's website, the ability to set up the present invention. Partners 832 will obviously include not just account aggregators 834 (such as seen in FIG. 3), but financial services providers 836 (for example as seen in FIG. 7), charity aggregators 838, for example the 3^{rd} party platform of FIG. 3, or those charity aggregators who customarily maintain large lists of possible charities along with their own services to connect people to these charities, and so on. Thus, the present invention may be provided through a partner's gateway instead of through the micro-self-taxing gateway.

Contrawise, the partners may wish to provide their content on the micro-self-taxing gateway software.

### EXAMPLE

The following table provides an example of the architecture and use of the invention. Columns going across are steps in the process while rows going down are different layers, partners and so on.

TABLE ONE:

| STEPS | SETUP | TRANSACTION | ALLOCATION | NOTIFICATION |
|---|---|---|---|---|
| Front End | (In app, phone, | Payment Cards | (In app, phone, | (In app, phone, |
| | mobile device, | or phone, mobile | mobile device, | mobile device, |
| | PC, etc) | device, PC, etc) | PC, etc) | PC, etc) |
| Back End | Account Setup | 1. Transaction | Charities | Social impact/ |
| | Link Multiple | Data | allocation | social media |
| | Accounts (incl. | 2. Micro | Saving accounts | Secure Future |
| | cards, banks, etc) | processing | allocation | |
| | Set Goals | 3. Threshold | | |
| Example: | Goals: 3% give | 100$ | 3$ donations | Social media, |
| | 2% save | | 2$ to savings | text, email, etc |
| Partner Examples | Dwolla | Yodlee | Charitable | |
| | Guidestar | Dwolla | Organications, | |
| | | Bank | “Worth FM”, | |
| | | Credit Union | Betterment, | |
| | | banks, credit | unions | |

A setup phase involves requesting from the consumer various items of information, both identification (name, establishing passwords, etc) and also banking (routing numbers, etc) and in addition, personal information for data mining value-added.

The transaction is the time when a purchase or other transaction is made which triggers the steps of the system as shown in FIG. 2, etc.

Allocation is the portion in which the distributions are made, notification steps allow the user to receive notifications of their donations and investments in order to provide positive reinforcement to the user's motivation.

Structurally, the front-end modules are those parts of the invention seen and used by the consumer: apps, webpages, etc. The back end on the other hand, detailed elsewhere herein, handles financial transactions, calculation, social media routine tasks, databasing, security and so on.

Example transaction would be a user who has spent 100$ on a transaction, and receives the small micro-self-taxation of saving, plus a micro-donation as well.

Partners/financial ecosystem layers include exemplary parts of the (present day) financial landscape which may partner with the invention to provide a seamless financial service to the consumer.

Additional points of the invention include the setup modules and functionalities which allow a customer to securely provide quite important, and sensitive, information when setting up their account with the system, which information includes items as diverse and important as debit and credit card and banking information, a preauthorization form to their bank to allow the transfers of the system at the time of purchases, personal information, ID, SSN and so forth.

As mentioned previously, a charity aggregator capable of providing the system with an exhaustive list of charities, both national and local, is one member of the system. An example of this might be the Orghunter database or Guidestar API or the NCCS database. A data aggregator such as Yodlee to provide transaction information to the system is another portion (as seen in FIG. 7).

Strategic partnerships are not limited to financial institutions, they may also be forged with charitable institutions to offer two-way charitable relationships, charitable involvement in fostering the social media engagement and more. Strategic partnerships with payment engine organizations such as Paypal, Venmo, Square Cash and so on are possible. Services like Dwolla can be used as well: all of these things are intended to reduce the user's fees while increasing their leverage.

Strategic partners could also include employers (providing employee engagement) or colleges and universities for student engagement, churches, benevolent orders, clubs, and so on and so forth.

The social media of the invention might be a dedicated community and platform created by the provider of this transaction service, or it might be a community within an already existing social media platform such as Facebook, Twitter, Google+, Snapchat, Kakaotalk, Instagram or the like: this latter route offers the advantages of the huge pre-existing customer bases and reduces start-up costs.

Crucially, customers can “SHARE” invitations to join the system, allowing the system to go viral and grow by word of mouth equivalent.

The system of the invention should preferably be touch ID enabled for biometric factor security.

### END EXAMPLE

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of self-taxing for savings and charitable donations by a consumer/payer having a checking account in at least one payer bank, in a banking system having: retailers/payees, a payee bank, a charity, at least one transaction data aggregator, and an ACH system for settlement; such payer also having a savings account, the method comprising the steps of:
1) such payer authorizing such payee to receive a payment; having an amount and having transaction data;
2) such payee requesting the payment via such payee bank;
3) such payee bank transmitting via such ACH system such request for the payment to such payer bank;
4) such payer bank transmitting via such ACH system the payment to such payee bank;
5) such payer bank reporting the payment to such payer and such payee bank reporting the payment to such payee;
6) in accordance with a preauthorization from such payer, reporting the payment to a self-taxing bank institution, the preauthorization comprising a table of rules;
7) the self-taxing bank institution, also in accordance with the preauthorization, initiating a transfer of a first amount of money from such payer's checking account at such payer's bank to a first sweep account set up with the consent of such payer and initiating an additional transfer of a second amount of money from such payer's checking account at such payer's bank to the first sweep account;
8) when a first threshold is reached, transferring a first amount of money from the first sweep account to a recipient;
9) when a second threshold is reached, transferring a second amount of money from the first sweep account to a second recipient;
10) using the transaction data, the preauthorization table of rules, the first amount of money and the second amount of money, updating a financial health score, the financial health score comprising a matrix of information about the financial health of the payer, including their spending habits, their transfers to the first recipient and their transfers to the second recipient.

2. The method of self-taxing of claim 1, for use by a second consumer/payer for savings and charitable donations, with a second payee and a second payer bank and a second payee bank, the method further comprising:
such second payer authorizing such second payee to receive a second payment; having a second amount and having second transaction data;
such second payee requesting the second payment via such second payee bank;
such second payee bank transmitting via such ACH system such request for the second payment to such second payer bank;
such second payer bank transmitting via such ACH system the second payment to such second payee bank;
such second payer bank reporting the second payment to such second payer and such second payee bank reporting the second payment to such second payee;
in accordance with a second preauthorization from such second payer, reporting the second payment to a second self-taxing bank institution, the second preauthorization comprising a second table of rules;
the second self-taxing bank institution, also in accordance with the second preauthorization, initiating a transfer of a third amount of money from such second payer's checking account at such second payer's bank to the FIRST sweep account set up with the consent of such FIRST payer and initiating an additional transfer of a fourth amount of money from such second payer's checking account at such second payer's bank to the FIRST sweep account;
whereby such third and fourth amounts of money of such second user are going to the same FIRST sweep account as the first and second amounts of money of such first user.

3. The method of self-taxing of claim 1, further comprising: the financial health score is in turn provided to a data marketer.

4. The method of self-taxing of claim 2, wherein the first recipient is such payer saving account and the second recipient is a charitable organization.

5. The method of self-taxing of claim 1, wherein the first threshold is one member selected from the group consisting of: a set time, a set amount of money, and combinations thereof.

6. The method of self-taxing of claim 1, wherein the sweep account is set up using one member selected from the group consisting of: the self-taxing bank institution, such payer's bank, a fourth bank institution affiliated with the self-taxing bank institution, and combinations thereof.

7. The method of self-taxing of claim 1, wherein the self-taxing bank institution offers and the payer may select, the first amount of money from a group consisting of: a percentage of the amount of the payment, rounding each transaction up to the next whole dollar amount, a fixed dollar amount for every transaction, and combinations thereof.

8. The method of self-taxing of claim 1, wherein the notification of step 6 occurs via such transaction data aggregator.

9. The method of self-taxing of claim 1, wherein the transfer of money from the payer's checking account is also an ACH transaction.

10. The method of self-taxing of claim 1, further comprising the step of:
9) aggregating data from each transaction into a database associated with such payer.

11. The method of self-taxing of claim 10, further comprising the step of:
10) offering to such payer an app module for use on a mobile device owned by such payer;
the app module operative to provide to such payer reports on their transfers, account balances, and transfer preauthorization settings; the app module further operative to provide to such payer the option to alter transfer preauthorization settings, alter the first threshold, perform banking functions, and authorize the payment.

12. The method of self-taxing of claim 11, wherein the app module is further operative gather additional data about such payment and aggregate such additional data into the database associated with such payer, the additional data comprising one member selected from the group consisting of: the transaction data, GPS data, data regarding a recent search made on the mobile device using an online search engine, and combinations thereof.

13. The method of self-taxing of claim 12, in which there are other payers using the self-taxing method, further comprising the steps of:
11) offering to such payer the opportunity to participate in a social media network relevant to the charitable institution;
wherein the app module is further operative to make the offer, receive feeds from the social media network regarding activities of such other payers, offer to such payer the opportunity to post to the social media network their own activities, automatically post to the social network, receive notifications from such payees, offer to such payer the opportunity to post to the social media network their own transfer-related activities, automatically post to the social network such payer's transfer related activities, and combinations thereof.
